(19) United States
(12) Patent Application Publication
(10) Pub. No.: US 2004/0068758 A1
(43) Pub. Date: Apr. 8, 2004

(54) Dynamic video annotation

(76) Inventors: Mike Daily, Thousand Oaks, CA (US); Ronald Azuma, Santa Monica, CA (US); Kevin Martin, Oak Park, CA (US); Howard Neely III, Manhattan Beach, CA (US)

Correspondence Address: TOPE-MCKAY & ASSOCIATES, 23852 PACIFIC COAST HIGHWAY #311, MALIBU, CA, 90265, US

(21) Appl. No.: 10/263,925

(22) Filed: Oct. 2, 2002

(51) Int. Cl. H04N 7/16

(52) U.S. Cl. 725/136

(57) ABSTRACT

The present invention allows a broadcaster 300a to encode a plurality of data, a portion of which may be from databases 302a, including spatial content and tracking data into a signal, the signal is sent to an overlay construction module 304a. Augmentation layers 306a, provided by users 308a are conveyed to the overlay construction module 304, where the signals are separably merged with the broadcast signal to create an augmented signal, which is transmitted, optionally via satellite 310a, to users 308a. The users 308a receive the augmented signal and display only the layers of interest to them. Thus each user may select a unique overlay combination, and experience individualized programming that more closely comports with that user's tastes.

### FIELD OF THE INVENTION

The present invention relates to multimedia communications and more particularly to the synchronized delivery of annotating data and video streams.

### BACKGROUND

TV, as it exists today, is largely a passive medium. Generally a central facility broadcasts a signal and millions of viewers receive the same signal. The signals are the basis for the resulting images and sound that are generally associated with broadcast television. Note that broadcast television is understood to include satellite-propagated television, cable-propagated television, and conventional terrestrially-propagated television. Because there is no opportunity to interact with such television, many viewers treat the TV signal as background noise, and only pay attention to the TV if something of interest occurs.

Various proposals and efforts exist to enhance TV signals and enhance viewer participation and attention. For example, one effort, Advanced Television Enhancement Forum, (ATVEF) is creating a standard for enabling HTML hypertext links associated with the content shown on the screen. ATVEF is refining an HTML-enhanced TV, where viewers can click on hypertext links to get sports statistics, see actor biographies, or order a pizza from a TV ad in direct response to what is currently being shown on the TV. Utilizing ATVEF the content is not spatially-located with respect to what is shown on the screen and users cannot create content themselves.

Other systems utilize “call in” format wherein viewers can telephone the broadcaster and speak with a show personality, or can send mail (electronic or conventional) and have the contents of the mailed message disseminated to the audience. These systems do very little to change the passive nature of the television. The friends of the person whose letter or call is taken might find the viewer input interactive, but for the other viewers the level of interaction is abysmally low.

### BRIEF DESCRIPTION OF THE FIGURES

The objects, features, and advantages of the present invention will be apparent from the following detailed description of the preferred aspect of the invention with references to the following drawings:

FIG. 1 is a depiction of the concept of layered data, a plurality of users create a plurality of layers which are merged and combined with the broadcast video image to produce a final image;

FIG. 2 is a depiction of a scene from a basketball game, with spatial labels indicating names and positions of one team's basketball players;

FIG. 3a is a diagram depicting the steps for augmenting data according to one aspect of the invention, wherein the augmentation layers provided by users are separably merged with the broadcast signal to create an augmented signal;

FIG. 3b is a diagram depicting the steps for augmenting data according to another aspect of the invention, wherein at least one of the augmentation layers provided by users are sent directly to users, thus creating an augmented signal;

FIG. 4 is an illustration of the overlay combination and selection process, wherein the broadcast signal contains not only the original video and audio signals associated with the programming, but additional layers of spatially located augmenting layers; and

FIG. 5 shows the overall system concept in block diagram form.

### SUMMARY OF THE INVENTION

One aspect of the present invention provides a method for interactively augmenting full motion video, wherein a full motion video signal stream is provided through a broadcaster, and at least one person provides augmenting data, in the form of a “layer,” which is laid over the video signal stream. This provided layer may be directed to a broadcaster, and accompanied with instructions on where to maintain the augmenting layer relative to the existing displayed elements, or alternatively, may be directed to a user. When directed toward a user the layer may include continuing instructions on where to maintain the augmenting layer. Finally, users may selectively view any combination of augmenting layers. The augmenting layers may include virtually any data, including geo-located data, a virtual spaces data, such as marking lines on fields, an audio commentary, a text based chat, or a general comments and contextual information. The augmenting layers takes may take a plurality of forms including a transparent overlay, the spatial enhancement of specified image components, and an opaque overlay. In an alternative aspect the method interactively augments full motion video and the augmenting layers include dynamic, spatially located, augmenting layers that the user can either select from or, if the user chooses, the user may create.

Yet another aspect provides an apparatus for interactively augmenting full motion video, including a means for receiving and displaying full motion video, such as a television set, a user interface configured to allow at least one user to provide an augmenting layer of data to a full motion video stream. It is anticipated that a computer mouse could serve as one such interface. Finally the invention provides a means for viewing augmented full motion video from at least one location. The provided augmentation might include placement instructions, and duration instructions. Further, the user interface may include a tracking means for keeping augmentation in a user specified position relative to an object displayed despite movement within a scene.

In yet another aspect the augmenting layers may include data from a distributed database, such as the Internet, or a plurality of centrally accessible private databases, a remote database, or a local database. The layers may be selected by the user, with the aid of an interface, thus allowing the user to interactively augment full motion video. The user augmenting data may be detected by the user by means of a plurality of strategically placed electromechanical transmitters or speakers, a full motion video receiver and display terminal, such as a television, and at least one electromechanical sensor such as a microphone.

### DETAILED DESCRIPTION

The present invention provides method and apparatus that provides data augmentation for images. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

One aspect of this invention includes a broadcast video signal configured to permit viewers to add and view additional layers of spatially located information. According to this aspect, the viewer can interactively select and/or create the layers. The selected or created layers can be combined with a tracking protocol to facilitate the continued relevance of the augmenting data when the objects of augmenting data, within a view, change position.

When implemented, the invention allows users to select from, or create a variety of content augmentation types to broadcast television images or a video stream. The types of content include geo-located data, which can include the identification of geographical landmark identification, or other geographically significant data. Data associated with virtual spaces could be included. Such virtual spaces data could include adding virtual first down lines, two-dimensional and three-dimensional structures, statuary, or other objects. Additionally, audio and text chat data could be included, or comments and contextual information. Each type of information is deemed a layer. The layers are optionally merged and combined with the broadcast video image to produce the final image that the user sees, or transmitted via terrestrial networks only to certain pre-specified users. Each user may see a somewhat different image, depending on what the user selects and contributes interactively. The layers may affect the broadcast image in a variety of ways. For example, they may be simple transparent overlays, or they may specify image-processing operations (e.g. spatial enhancement) to certain parts of an image, etc.

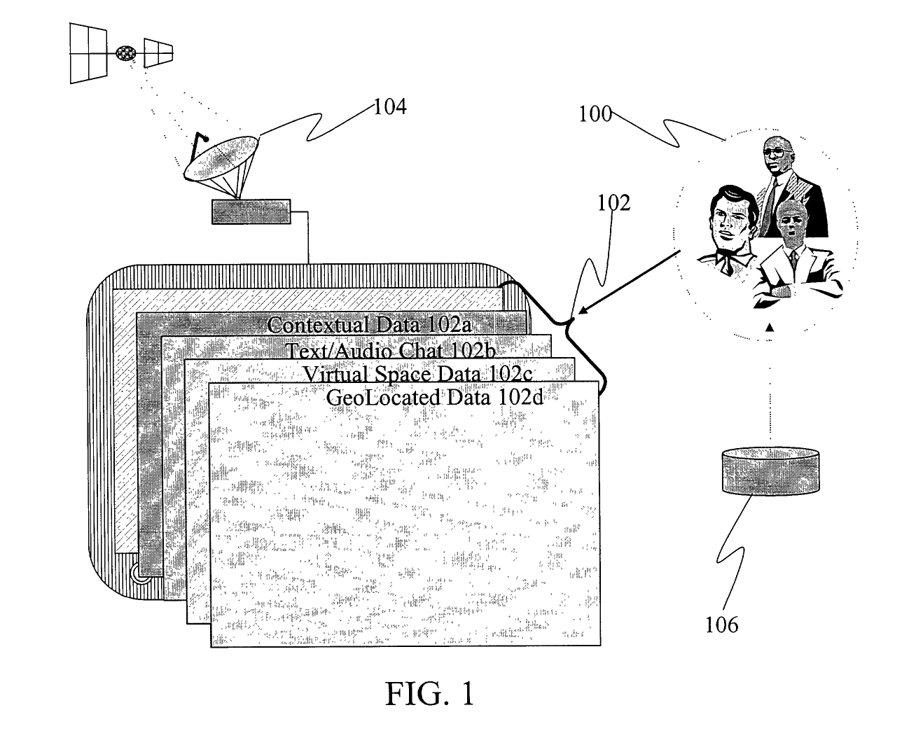

A conceptual depiction of the concept of the layered data is provided in FIG. 1, where a plurality of users 100 create a plurality of layers 102, in this instance, contextual data 102a, text or audio “chat” data 102b, virtual space data 102c, and geolocated data 102d. The layers 102 are merged and combined with the broadcast video image 104 to produce the final image that the user sees. The users 100 may utilize a plurality of techniques in creating the layered annotations 102, wherein some of these annotations are created with the aid of a database 106. The database could be a distributed database such as the Internet or a local database, or even a non-distributed remote database.

The present invention goes beyond existing systems for enhanced TV by augmenting basic video streams with layers of additional, spatially located information that the user can either select from or create. Individual users may choose information annotations appropriate to their interests and can place their own annotations on live and recorded video streams. This form of interaction essentially enables communication between viewers through the information in the layers. These annotations enable a new kind of broadcast television and video programming wherein the user interaction can be as interesting as the programming content, and the programming in fact becomes an augmented form of content. For example, when watching a sporting event, a group of users might provide their own commentary to share amongst a group rather than relying solely upon what a sportscaster says.

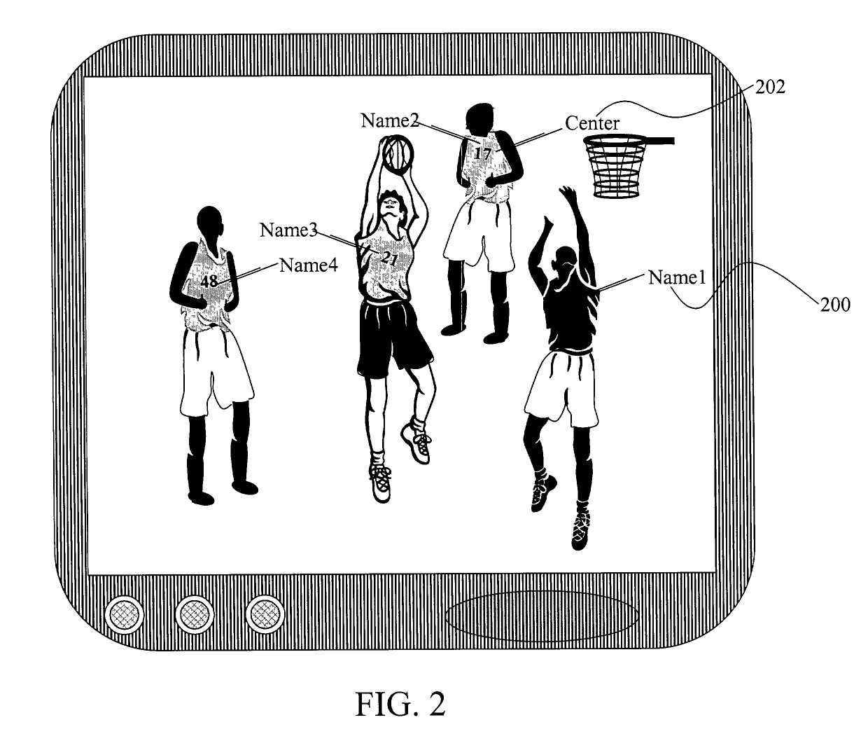

As compression systems improve and bandwidth is used more efficiently, augmented TV content provides a compelling use of this additional bandwidth. For instance, popular channels and events (e.g. sports events) draw large numbers of viewers and particularly lend themselves to audience participation. Generally, sporting events can benefit from some level of augmentation. There are numerous examples of spatial information that people viewing a broadcast of a basketball game could view to enhance their understanding and enjoyment of the game. An example would be adding spatial labels, and is illustrated in FIG. 2, where the names 200 of the players is presented and the players positions 202 are indicated. It is often difficult to tell who is who on the court, as the numbers of the shirts are not always visible to the TV viewers. Similarly, in a situation where a 3-point shot is needed, labels could indicate the good 3-point shooters and their shooting percentages. Other statistics, such as number of fouls on each player, free throw shooting percentage, etc. could be drawn as desired. Further, viewers could insert the shot charts, which would graphically show where a player has shot from the floor on the live broadcast view.

In addition to the content provided by the broadcaster, users could join small groups and share information with each other. Communications between users can be accomplished via a standard chat server, or through a multicast group that is set up dynamically when users join in. The users are able to actually add comments to the video stream. Audio comments could also be spatially positioned, given sufficient bandwidth and sound spatialization, at each user's home. This would mimic a “sports bar” atmosphere in the users' living rooms, where a user could verbally comment about the events in the game with a few other friends and hear their comments apparently coming from specific points in the room, as if they were there.

In another aspect of the present invention, small working groups of geographically-separated people could collaborate, all of them looking at a video signal with enhanced content that is broadcasted to the entire group. For example, consider a military command and control application, wherein several military personnel are observing a situation in the field; some of the observers could be at the scene, while others are at a distant command post. An officer at the scene could describe the situation, not just by making an audio report but also by sketching spatial annotations upon the scene. For instance, the officer could narrate the video footage identifying an enemy position and a proposed plan of attack. All the viewers could see the enhanced spatial video content and offer comments and criticisms.

Another application is setting up remote film locations for filming. In a movie production, production filming may occur at several sites simultaneously, and an overall director and producer would like to be able to monitor each site, and be involved in decision-making in matters related to the filming. Several people could be involved in a teleconference, with the video signal coming from a cameraman at the remote site. Additionally, 3-D computer graphics could be inserted into their proper spatial locations to give a rough idea of what the sets, once constructed, will look like and where the special effects will be added. The director and producer who are not at the remote site could then get a much better idea of the final result would look like and could take remedial action, if the scene did not comport with their expectations. Generally, the invention finds application in any situation where enhanced broadcast video signals are desirable, or where users find it desirable to add and interact with spatial content. Such situations could further include SWAT team members and police chiefs planning an operation, city planners studying the impact of a proposed new set of buildings, archeologists reporting on findings from a dig site, and security personnel pointing out a suspect spotted on security cameras and following his movements, etc.

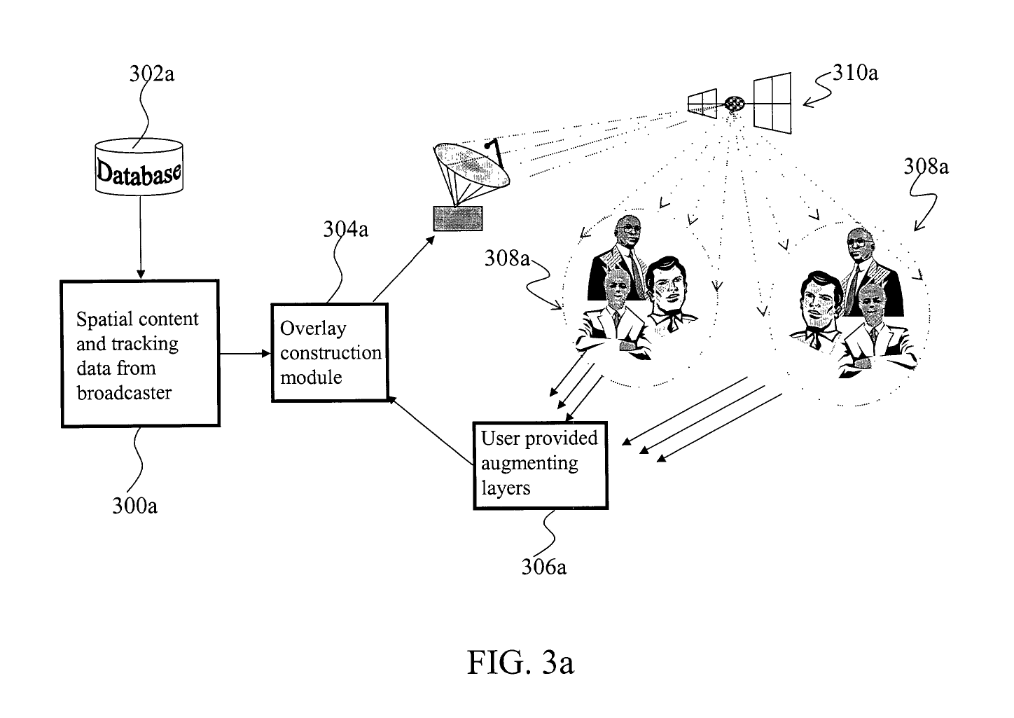

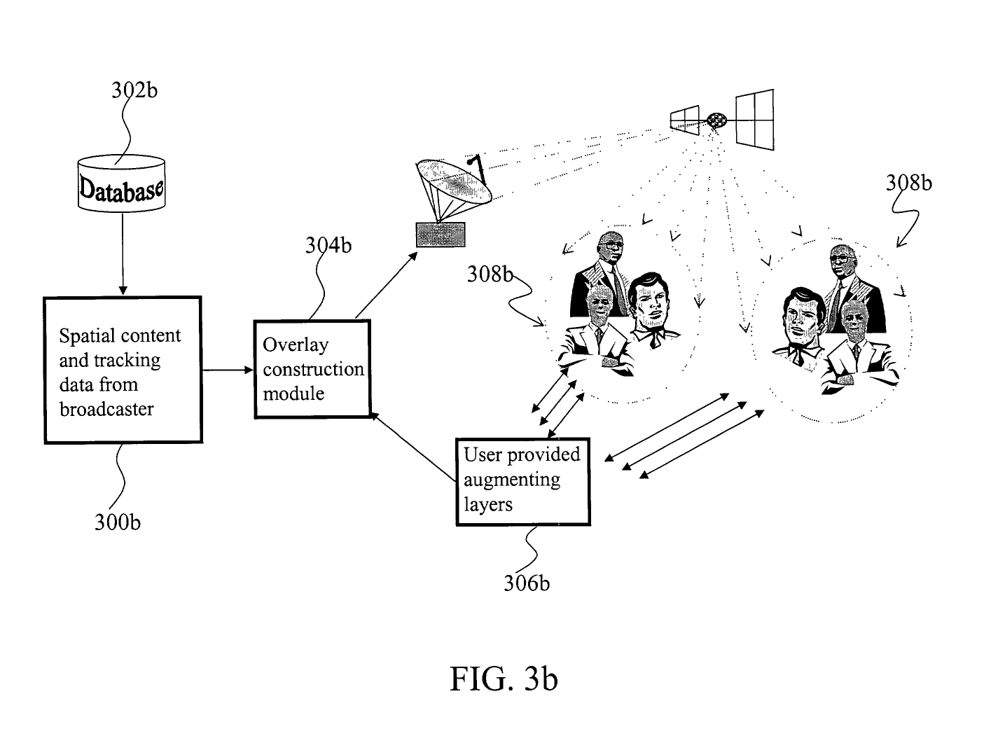

A conceptual block diagram depiction of the invention is presented in FIG. 3a. A broadcaster 300a encodes a plurality of data, a portion of which may be from databases 302a, including spatial content and tracking data into a signal, the signal is sent to an overlay construction module 304a. Augmentation layers 306a provided by users 308a are conveyed to the overlay construction module 304a, where the signals are separably merged with the broadcast signal to create an augmented signal, which is transmitted, optionally via satellite 310a, to users 308a. The users 308a receive the augmented signal and only display the layers of interest to them. Thus each user may select a unique overlay combination, and experience individualized programming that more closely comports with that user's tastes.

In an alternative aspect, shown in FIG. 3b, in block diagram form. A broadcaster 300b encodes a plurality of data, a portion of which may be from databases 302b, including spatial content and tracking data into a signal, the signal is sent to an overlay construction module 304b. Augmentation layers 306b provided by users 308b, are either conveyed to the overlay construction module 304b, where the signals are separably merged with the broadcast signal, or are transmitted directly to a plurality of users. In all cases the user selects the layer of interest and is thereby able to create an augmented signal, which is transmitted to users 308b. The users 308b receive augmented signals and only display the augmenting layers of interest to them. Thus each user may select a unique overlay combination, and experience individualized programming that more closely comports with the users' tastes. The selection of the layers could be accomplished by either electing a certain layer, or by scanning through the layers associated with channel until one or more layers of interest appear.

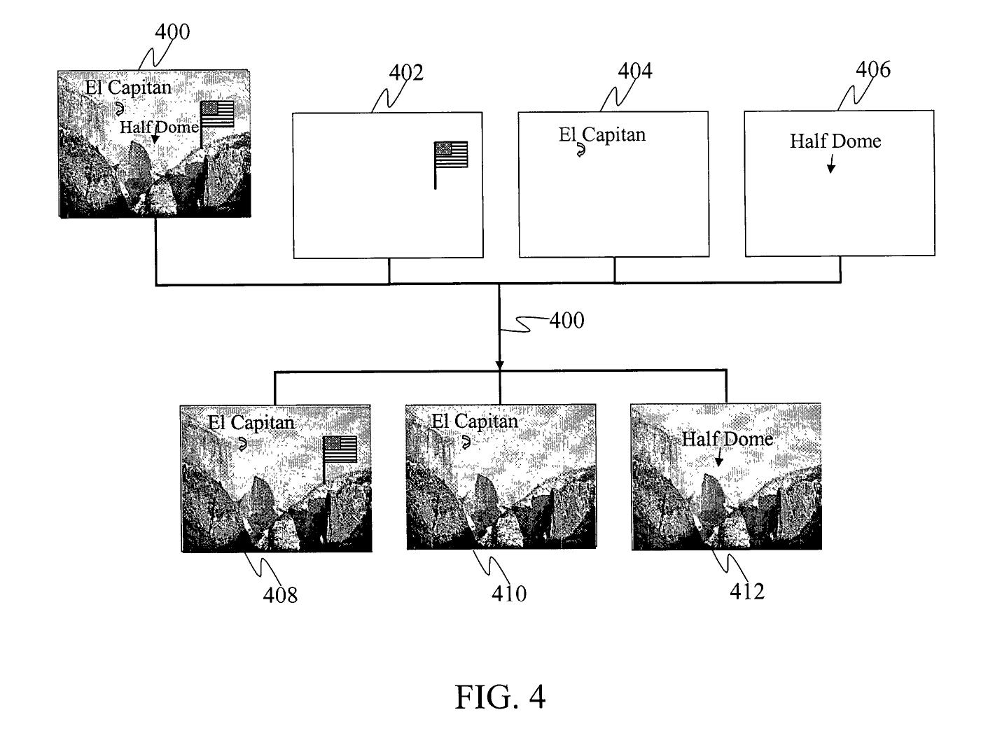

Referring now to FIG. 4, a series of images is presented that illustrates the overlay combination and selection process. The broadcast signal 400 contains not only the original video and audio signals associated with the programming, but also additional layers of spatially located information called augmenting layers. Three examples are shown here, the first is an image of a flag 402 placed in the foreground. The second layer is a text label layer 404 used to point out and label certain landmarks. The third layer is an additional text layer 406. Viewers may then select which layers they wish to view. A first viewer 408 may choose a text and a video annotation, in this the identification of El Capitan and a flag. A second viewer 410 may only be interested in the identification of El Capitan and a third viewer 412 may only be interested in an annotation related to Half Dome. The annotation can be in the form of 2-D or 3-D models combined with information on where to place the models. The user's settop box would then render the augmented images from the data, reducing the required broadcast bandwidth but increasing the computation load at the settop box. Each user is free to select which layer or combination of layers to view. In this example, each of a plurality of users may select different combinations of layers to view. Therefore, each user can view a different enhanced image. While FIG. 4 demonstrates this concept with video images, the system would similarly work with audio content and spatialized sound to place the audio sources at certain locations in the environment.

An important component of the invention is the synchronization of the video image and the enhanced data content. If the two are not synchronized the enhanced content may not be placed in the correct location on the video image. A simple way to ensure synchronization is have the broadcast signal include new content for each layer for every new frame of video. These layers could be compressed for further bandwidth reductions. The overlays, as shown in FIG. 4, could be combined by treating the augmenting layers as transparent layers that are layered one on top of another. Alternatively, the augmentation could be a semi-transparent layer, and the layer could serve as an image-based operator (e.g. for blurring), etc. This may find application, for example, where an adult wants to limit a minors exposure to certain offensive programming.

The augmenting layers can be created in a variety of locations. For instance the augmentation layers may be created by a broadcaster, or by a user. The process for creating layers may vary depending on whether the source content is displayed in real time (e.g. a sporting event) or non real time (e.g. a documentary). Consider the case where the augmenting data is added by the broadcaster. The broadcaster, in one scenario, must identify certain spatial locations that can be annotated and must provide, for each annotated frame, the coordinates of those locations. These locations may change in time, as the camera or the objects move. Once given the spatial coordinates, the world coordinate system and the camera location, rendering the layers is straightforward. The difficult part is measuring and providing the coordinates for the annotations.

The method used to provide these coordinates will vary depending on the application and the content of the broadcast video program and is not something where all the possibilities can be easily listed. A variety of tracking systems exist, including optical, magnetic, radio, ultrasonic, and inertial means. Differential GPS is also an option for position tracking in outdoor situations. If broadcast is not live, another option is for a human being to manually track the locations of the relevant objects and store those for later rebroadcast. For live broadcasts, the task is often more difficult. Consider the example of a sporting event. The FoxTrak hockey puck tracking system gives one example of a successful tracking system. For a basketball game, it might be desirable to track the position of all the players on the floor. One approach would be to use an optical tracking system and a camera that looked down upon the court. Calibration is required to account for any distortion caused by the wide field of view, or alternatively multiple camera systems with small fields of view could be used. The computer vision system would track the locations of the players, using methods similar to those used in missile target tracking applications. To increase the robustness of the tracking, the system might require some manual intervention where human beings would initialize the target tracking and help the system reacquire individual players once the system “loses lock” in tracking (e.g. after a pileup going for the ball, or when players go to and leave the bench). The fixed cameras observing the court have predetermined positions and mechanical trackers can measure their orientation and zoom. In this case, every object of relevance (i.e. players, coaches etc.) could be tracked and home viewers could associate their comments with the tracking protocol. For instance a home viewer might comment on a particular player, the comment could be associated with that players tracking and thus the comment will follow the player as the player moves about the court. Additionally, distinctive shapes of non-dynamic elements can provide spatial clues allowing floor positions or other static imagery to be annotated or augmented. Other tracking systems could be used for different applications. For example, hybrid-tracking combinations of differential GPS receivers, rate gyroscopes, compass and tilt sensors, and computer vision techniques can be configured to provide real-time, accurate tracking in unprepared environments.

In addition to providing the coordinates of annotation points, the broadcaster or home user can also provide data attached to those annotation locations. These can be anything of interest associated with those locations, such as the statistics associated with a particular basketball player, or personal comments related to a user's opinion of a player's performance. Broadcaster supplied data can be drawn from a variety of sources, most of which are already available to broadcasters covering sporting events.

Optionally, users may also contribute content that can be added to the broadcast layers. The users do not specify the exact coordinates where their content to be displayed but can select one or more annotation locations that the broadcaster provides. User data can take the form of chat data (audio and text) or virtual 2-D and 3-D models. One difficulty in incorporating the user content is the time delay involved. It may take a few seconds for the data that the user submits to appear in the broadcast. For example, users could establish a network connection to the broadcaster, probably through a phone line or some other means. The user would submit the content along with his group ID number and the ID of the annotation point where the content should be attached. This step will involve some latency due to network delays. The broadcaster then must update its database with the new data, add that to the data to be broadcast signal and transmit the signal. The use of annotation locations provided by the broadcaster is key to maintain the correct alignment of the augmenting content over the video stream. The broadcaster is responsible for providing the spatial locations and ensuring that they are synchronized to the video signal. The data can then be assigned to specific annotation locations. Individual users may provide annotation directly to a plurality of other users, instead of going through the broadcaster.

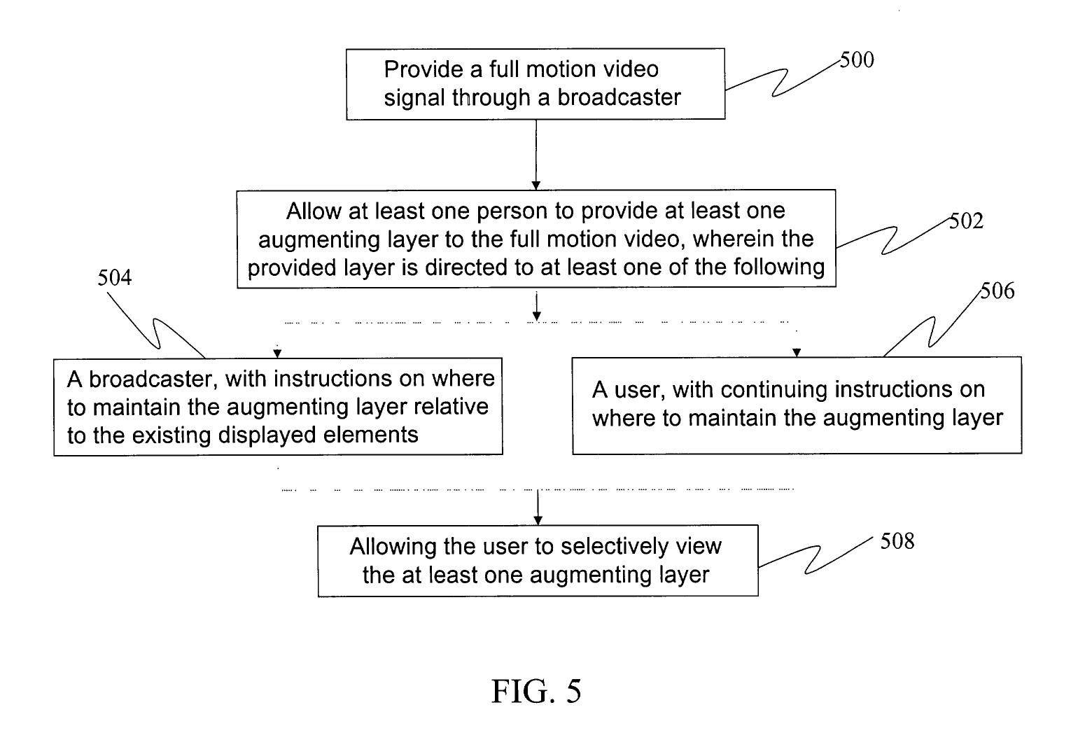

An alternative aspect of the present invention, as set forth in FIG. 5, provides a method for interactively augmenting full motion video, comprising the following steps: The first step 500 includes providing a full motion video signal through a broadcaster this could be any type of broadcaster, including a satellite based broadcasting system, a more conventional terrestrial based broadcasting system, or a cable based broadcasting system. The second step 502 allows at least one person to provide at least one augmenting layer to the full motion video, wherein the provided layer is directed to a broadcaster or a user. In either case there is an instruction step. If sent to a broadcaster there is a broadcaster instruction step 504, which includes instructions on where to maintain the augmenting layer relative to the existing displayed elements. The user instruction step 506 allows a user to provide continuing instructions on where to maintain the augmenting layer. Finally there is a selection step 508 where a user selects which augmenting layers to view.

1. A method for interactively augmenting full motion video, comprising the steps of:
i. providing a full motion video signal through a broadcaster;
ii. providing at least one augmenting layer to the full motion video, wherein the provided layer is directed to at least one of the following:
a. a broadcaster, with instructions on where to maintain the augmenting layer relative to the existing displayed elements and
b. a user, with continuing instructions on where to maintain the augmenting layer; and
iii. allowing the user to selectively view the at least one augmenting layer.

2. A method for interactively augmenting full motion video as set forth in claim 1, wherein the augmenting layer is created by adding at least one of the following layers:
i. a geo-located data layer;
ii. a virtual spaces layer;
iii. an audio chat layer;
iv. a text chat layer; and
v. a comments and contextual information layer.

3. A method for interactively augmenting full motion video as set forth in claim 2, wherein the augmenting layers are merged and combined with the broadcast video image to produce a final video stream.

4. A method for interactively augmenting full motion video as set forth in claim 2, wherein a user may selectively turn the augmenting layers on or off.

5. A method for interactively augmenting full motion video as set forth in claim 2, wherein the augmenting layers takes at least one of the following forms:
i. a transparent overlay;
ii. spatial enhancement of specified image components; and
iii. an opaque overlay.

6. A method for interactively augmenting full motion video as set forth in claim 2, wherein the augmenting layers include dynamic spatially located augmenting layers that the at least one user can either select from or create.

7. A method for interactively augmenting full motion video as set forth in claim 1, wherein information annotations may be selected by the at least one user based on augmenting layers that are appropriate to their interests.

8. A method for interactively augmenting full motion video as set forth in claim 1, wherein the augmenting layers enable communication between viewers through the information in the layers.

9. A method for interactively augmenting full motion video as set forth in claim 1, wherein a plurality of the augmenting layers are provided by the full motion video broadcaster.

10. A method for interactively augmenting full motion video as set forth in claim 9, wherein the plurality augmenting layers provided by the full motion video broadcaster includes:
i. statistics relevant to the programming;
ii. historical data relevant to the programming; and
iii. commentary specifically directed to a subset of viewers.

11. A method for interactively augmenting full motion video as set forth in claim 1, wherein the augmenting layer is conveyed to a full motion video broadcaster and broadcaster transmits the full motion video signal and augmenting layer signal.

12. A method for interactively augmenting full motion video as set forth in claim 1, wherein the user interface communicates utilizing at least one of the following:
i. an Internet connection;
ii. a wireless network;
iii. a telephone line; and
iv. a local satellite uplink.

13. A method for interactively augmenting full motion video as set forth in claim 12, wherein the telephone line communicates the augmenting layer:
i. to at least one user, without going through a broadcaster; or
ii. to at least one user via a broadcaster.

14. A method for interactively augmenting full motion video as set forth in claim 1, wherein the Internet connection communicates the augmenting layer:
i. to at least one user, without going through a broadcaster; or
ii. to at least one user via a broadcaster.

15. An apparatus for interactively augmenting full motion video, comprising:
i. a means for receiving and displaying full motion video;
ii. a user interface configured to allow at least one user to provide an augmenting layer of data to a full motion video stream;
iii. a means for viewing augmented full motion video from at least one location.

16. An apparatus for interactively augmenting full motion video as set forth in claim 15, wherein the user interface, allows the at least one user to provide augmentation data and augmentation data placement instructions,

17. An apparatus for interactively augmenting full motion video as set forth in claim 15, wherein the user interface includes a tracking means for keeping augmentation in a user specified position relative to an object displayed despite movement within a scene.

18. An apparatus for interactively augmenting full motion video as set forth in claim 15, wherein the user interface is selected from at least one of the following:
i. a mouse;
ii. a keypad;
iii. an e-pen and c-pad; and
iv. a microphone.

19. An apparatus for interactively augmenting full motion video as set forth in claim 15, wherein the user interface is operatively interconnected with at least one of the following sources of augmenting data:
i. a distributed database;
ii. a remote database; and
iii. a local database.

20. An apparatus for interactively augmenting full motion video as set forth in claim 15, wherein the user interface communicates utilizing at least one of the following:
v. an Internet connection;
vi. a wireless network;
vii. a telephone line; and
viii. a local satellite uplink.

21. An apparatus for interactively augmenting full motion video as set forth in claim 15, wherein the user interface includes at least one of the following:
i. a means for selectively displaying augmentation layers;
ii. a plurality of strategically electromechanical transmitters;
iii. a full motion video receiver and display terminal; and
iv. at least one electromechanical sensor.

22. A method for interactively augmenting full motion video, comprising the steps of:
i. providing a full motion video signal through a broadcaster;
ii. allowing at least one user to provide at least one augmenting layer to the broadcaster with instructions on how to maintain the augmenting layer relative to elements existing in the full motion video; and
iii. transmitting the augmented signal to at least one user.
